(19) United States
(12) Patent Application Publication
(10) Pub. No.: US 2023/0071759 A1
(43) Pub. Date: Mar. 9, 2023

(54) SYSTEMS, DEVICES AND METHODS FOR ADDING CAPACITY TO A FIBER OPTIC NETWORK

(71) Applicant: COMMSCOPE TECHNOLOGIES LLC, Hickory, NC (US)

(72) Inventors: Jan Jozef Julia Maria ERREYGERS, Tielt-Winge (BE); Douglas Ferris DOWLING, Cary, NC (US); Erik J. GRONVALL, Bloomington, MN (US)

(73) Assignee: COMMSCOPE TECHNOLOGIES LLC, Hickory, NC (US)

(21) Appl. No.: 17/799,194

(22) PCT Filed: Feb. 12, 2021
(86) PCT No.: PCT/US2021/017945

§ 371 Date: Aug. 11, 2022

Related U.S. Application Data
(60) Provisional application No. 62/975,382, filed on Feb. 12, 2020.

(51) Int. Cl. H04B 10/27

(52) U.S. Cl. CPC H04B 10/27

(57) ABSTRACT

A method for increasing the capacity of a passive optical network. The passive optical network includes an existing multi-service terminal having a plurality of hardened fiber optic drop ports, and also includes an optical line terminal that provides service to the existing multi-service terminal. The method includes upgrading the optical line terminal to support at least 10GPON and to have increased launch power and enhanced loss sensitivity. The method also includes adding a passive optical splitter between the optical line terminal and the existing multi-service terminal, connecting the existing multi-service terminal to a first output of the passive optical splitter, and connecting an expansion multi-service terminal to a second output of the passive optical splitter.

### CROSS-REFERENCE TO RELATED APPLICATION

This application is being filed on Feb. 12, 2021 as a PCT International Patent Application and claims the benefit of U.S. Patent Application Ser. No. 62/975,382, filed on Feb. 12, 2020, the disclosure of which is incorporated herein by reference in its entirety.

### TECHNICAL FIELD

The present disclosure relates to fiber optic communication systems. More particularly, the present disclosure relates to devices, systems and method for adding capacity to a fiber optic network such as a passive fiber optic network.

### BACKGROUND

Passive optical networks (e.g., “fiber-to-the-home” or “fiber-to-the-premises”) are prevalent in part because service providers want to deliver high bandwidth communication capabilities to customers. Passive optical networks are a desirable choice for delivering high-speed communication data because they are not required to depend upon active electronic devices, such as amplifiers and repeaters, between a central office and a subscriber location. The absence of active electronic devices may decrease network complexity and/or cost and may increase network reliability. Common architectures for passive optical networks are dependent upon the use of passive optical power splitters which enable one fiber from a service provider's central office to serve multiple subscribers (e.g., homes, businesses, etc.). Some fiber optic network architectures utilize passive optical splitters positioned at more centralized locations such as fiber distribution hubs. Other passive optical networks use a distributed architecture in which passive optical splitters are more distributed throughout the network (e.g., see U.S. Pat. No. 7,444,056). Other passive optical networks can use distributed tap architectures such as disclosed by PCT International Publication No. WO2018/231833.

GPON (gigabit-capable passive optical network) is a traditional optical networking standard for data links of passive optical networks. GPON provides for downstream data speeds of 2.5 gigabits per second and upstream data speeds of 1.25 gigabits per second. The demand for increased network speeds has resulted in faster technologies capable of supporting enhanced standards. An example enhanced standard includes XG-PON, defined by ITU-T G.987, which specifies data speeds of 10 gigabits per second downstream and 2.5 gigabits per second upstream. Another example enhanced standard includes XGS-PON, defined by ITU-T G.9807.1, which specifies data speeds of 10 gigabits per second both upstream and downstream. XGPON and XGS-PON are both examples of 10 G-GPON.

### SUMMARY

The present disclosure relates generally to systems, devices, and methods for increasing the capacity of a fiber optic network such as a passive fiber optic network. In one example, aspects of the present disclosure relate to adding a passive optical splitter to an existing fiber optic network to increase the capacity of the fiber optic network. In one example, a passive optical splitter is a 1×2 passive optical splitter, but other split ratios could also be used. In one example the passive optical splitter has a hardened configuration, but in other examples unhardened splitters can also be used. In certain examples, the passive optical splitter is added at a hardened connection location of the existing fiber optic network, but in other examples the passive optical splitter may be added at non-hardened connection locations. Aspects of the present disclosure also relate to device configurations incorporating splitters that are adapted to facilitate adding passive optical splitting to a fiber optic network at a date after the initial install of the fiber optic network.

Another aspect of the present disclosure relates to a method for increasing the capacity of a passive optical network. The passive optical network can include an existing multi-service terminal having a plurality of hardened fiber optic drop ports. The passive optical network also can include an optical line terminal that provides service to the existing multi-service terminal. The method includes upgrading the optical line terminal to support at least 10 GPON and to have enhanced sensitivity for the received signal and enhanced launch power. The method also includes adding a passive optical splitter at a location positioned between the optical line terminal and the existing multi-service terminal. The method further includes connecting the existing multi-service terminal to a first output of the passive optical splitter, and connecting an expansion multi-service terminal to a second output of the passive optical splitter.

A variety of additional aspects will be set forth in the description that follows. The aspects can relate to individual features and to combinations of features. It is to be understood the both the forgoing general description and the following detailed description are exemplary and explanatory only and are not restrictive of the broad concepts upon which the embodiments disclosed herein are based.

### BRIEF DESCRIPTION OF THE DRAWINGS

The accompanying drawings, which are incorporated in and constitute a part of this description, illustrate several aspects of the present disclosure. A brief description of the drawings is as follows:

FIG. 1 schematically depicts an example prior art passive fiber optic network architecture;

FIG. 2 depicts a hardened fiber optic adapter used by the architecture of FIG. 1;

FIG. 3 depicts an architecture in accordance with the principles of the present disclosure which represents an example in accordance with the principles of the present disclosure for upgrading and increasing the capacity of the fiber optic architecture of FIG. 1;

FIG. 4 depicts a hardened fiber optic splitter that can be incorporated in the architecture of FIG. 3;

FIG. 5 depicts another prior art passive optical network architecture;

FIG. 6 schematically depicts a fiber optic architecture in accordance with the principles of the present disclosure which represents an example in accordance with the principles of the present disclosure for upgrading and increasing the capacity of the fiber optic network of FIG. 5;

FIG. 7 depicts an example hardened passive optical splitting device that can be used in the architectures of FIG. 6;

FIG. 8 depicts another configuration for a hardened fiber optic splitting device that can be incorporated in the fiber optic architectures of FIGS. 6;

FIG. 9 schematically depicts another prior art fiber optic network architecture;

FIG. 10 schematically depicts a fiber optic network architecture in accordance with the principles of the present disclosure which represents an example in accordance with the principles of the present disclosure for upgrading and increasing the capacity of the network architecture of FIG. 9;

FIG. 11 depicts an example hardened splitting device that can be utilized in practicing the architecture of FIG. 10;

FIG. 12 schematically depicts a fiber optic network architecture in accordance with the principles of the present disclosure which represents another example in accordance with the principles of the present disclosure for upgrading and increasing the capacity of the fiber optic network architecture of FIG. 9;

FIG. 13 depicts an example hardened splitting and pass-through device that can be utilized in practicing the architecture of FIG. 12;

FIG. 14 depicts an example prior art MST;

FIG. 15 shows fiber routing within the MST of FIG. 14;

FIG. 16 is a cross-sectional view through a hardened fiber optic adapter of the MST of FIG. 14;

FIG. 17 depicts an example prior art hardened fiber optic connector adapted to mate with a hardened outer port of the fiber optic adapter of FIG. 16; and

FIG. 18 depicts another example prior art fiber optic adapter having a hardened port and a corresponding hardened fiber optic connector adapted to be received within the hardened port of the fiber optic adapter.

### DETAILED DESCRIPTION

Certain aspects of the present disclosure relate to expanding a passive optical network using splitters such as passive optical power splitters (e.g., splitters having a 1×2 split ratio or other split ratios). However, GPON networks are often designed up to the maximum attenuation budget. Hence, additional splitters added to the network may cause the total loss to be too high. However, there are currently different classes of device (e.g., different classes of Optical Line Terminals (OLT's)) that are categorized based on their ability to support different levels of loss (e.g., based on their ability to operate in accordance with different loss budgets for different fiber optic systems). Therefore, one solution for allowing the addition of optical splitters to a GPON network involves upgrading the OLT of the GPON network to a version with higher power and higher sensitivity which is compatible with a system having higher loss. By upgrading the GPON OLT, the existing ONT's (Optical Network Terminals) already installed in the GPON network can continue to be used with the OLT carrying the burden of higher launch power and higher receiver sensitivity. In certain examples, the OLT can be further upgraded by replacing an existing GPON line card with an upgraded card (MPM Card or Multi-Protocol-Module Card) capable of providing both GPON and 10G-GPON. In this way, the 10G-GPON can provide increased bandwidth as needed to support the expansion of the network. This approach is advantageous because additional space is not needed for the 10G-GPON OLT and a co-existing element is not needed to be separately installed since such capability will be integrated into the MPM line card. If as part of the card replacement the GPON is upgraded to support additional loss as described above, the network will be able to incorporate additional passive optical splitters without violating attenuation requirements. The added benefit is that 10G-GPON and GPON can be provided to both an existing terminal (e.g., an existing Multi-Service Terminal (MST)) coupled to the added splitter as well as to an expansion terminal (e.g., an expansion MST) connected to the added splitter.

Optical network units are used to provide connections between a subscriber location and a passive optical network. An example of an optical network unit is an optical network terminal (ONT). An ONT typically functions as a demarcation point for servicing a subscriber such as a home or business. An ONT device can be adapted to provide Ethernet and other services to end subscribers. An ONT can include optical to electrical conversion circuitry for converting optical signals from the optical network to electrical signals used at the subscriber location. The ONT typically also includes receiving capability for receiving data transmitted downstream from the OLT, and transmitting capability for transmitting data upstream to the OLT.

It will be appreciated that optical line terminals include transmitters and receivers. The transmitters include laser generators that are adapted to provide a predetermined power level of laser, and the receivers are rated to a particular sensitivity. The class of optical line terminal used in a fiber optic network establishes the optical power budget for the network. Example classes of optical line terminals include Class A which supports a loss up to 20 decibels, Class B which supports a loss up to 25 decibels, Class B+ which supports a loss up to 28 decibels, Class C which supports a loss of up to 30 decibels, Class C+ which supports a loss up to 32 decibels and recently proposed Class D which supports a loss up to 35 decibels. It will be appreciated that optical line terminals are designed to support higher losses and to provide larger power budgets by having increased receiver sensitivity, and increased transmitter laser power.

Optical line terminals can also be designed to support different bandwidth requirements. For example, to comply with GPON standards, the OLT should be capable of supporting 2.5 gigabits per second in the downstream and 1.25 gigabits per second in the upstream directions. 10G-GPON (also known as XGPON) specifies 10 gigabits per second downstream and 2.5 gigabits per second upstream. The standard for 10G-GPON is ITU-T G.987. XGS-PON is similar to XG-PON except XGS-PON is symmetric and supports 10 gigabits per second in both upstream and downstream directions.

Optical line terminals (OLT) are typically located at a central location of a service provider and are designed to connect passive optical networks to aggregated back-haul uplinks, to allocate time slots for transmitting upstream data from subscribers, and for transmitting shared downstream data in broadcast-mode over the passive optical network to subscribers. It will be appreciated that 10G-GPON is designed to coexist with GPON devices. Therefore, conversion to 10G-GPON capability can be accomplished by upgrading optical line terminals, and then converting individual optical network units corresponding to specific subscribers as needed. For example, based on customer preference, GPON compatible or 10G-GPON compatible ONT's can be used at the subscriber locations. In certain examples, a customer may choose to upgrade from a GPON compatible ONT to a 10G-GPON compatible ONT. In certain examples, ONT's compatible with both GPON and 10G-GPON can be used.

A multi-service terminal (MST) is an enclosure that is commonly installed near the outer edge of a fiber optic network to provide optical connection locations for connecting subscribers to the fiber optic network. A typical MST is an enclosure having a plurality of hardened fiber optic adapter ports that are accessible from outside the enclosure. The hardened fiber optic adapter ports are adapted to receive hardened fiber optic connectors terminating the ends of drop cables. A drop cable is typically routed from a port of an MST to a subscriber location. For example, the drop cable can be routed from the MST to an ONT at the subscriber location such that service is provided to the ONT via an optical line coupled to the fiber optic network.

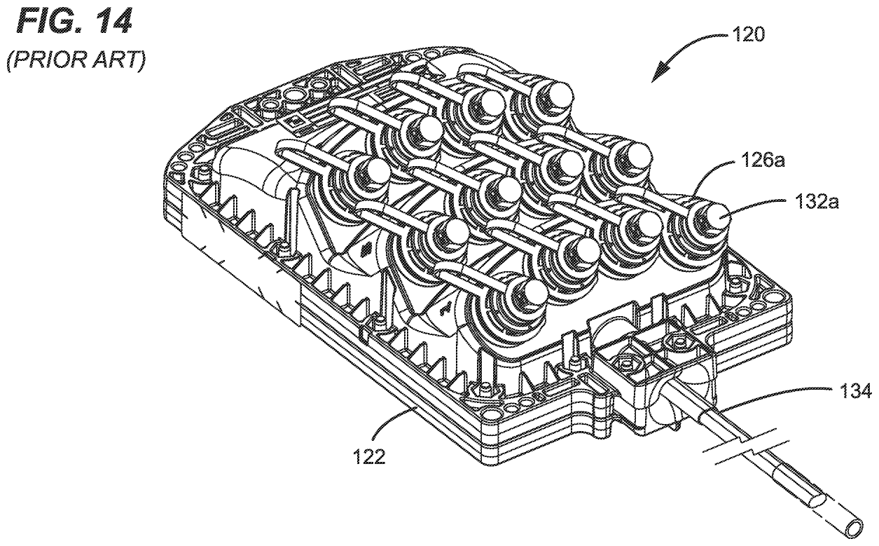

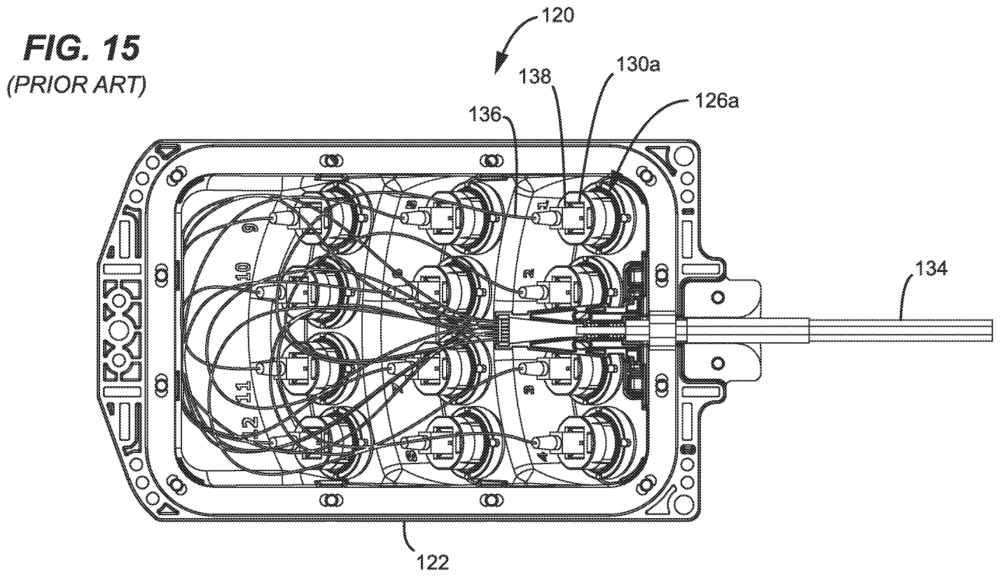

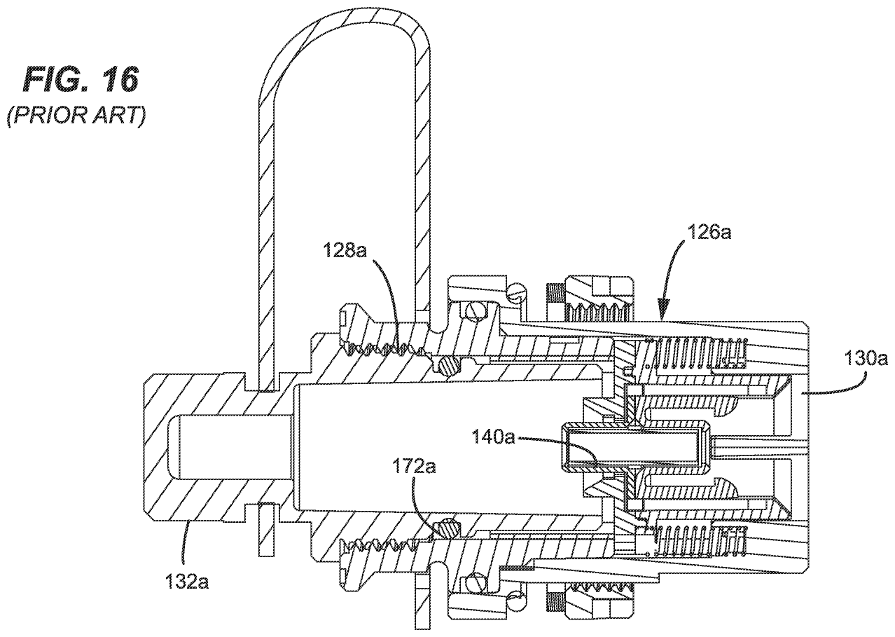

FIGS. 14 and 15 depict an example MST 120. The MST 120 includes a housing 122 that is preferably environmentally sealed. A plurality of hardened fiber optic adapters 126a are mounted to the housing 122. Each of the hardened fiber optic adapters 126a includes a hardened outer port 128a (see FIG. 16) accessible from outside the housing 122, and a non-hardened inner port 130a (see FIG. 16) accessible from inside the interior of the housing 122. The hardened outer ports 128a can be closed by exterior plugs 132a when not in use. As shown at FIGS. 15 and 16, a fiber optic cable 134 is routed into the interior of the housing 122. The fiber optic cable 134 is depicted including a plurality of optical fibers 136. Non-hardened fiber optic connectors 138 terminate the ends of the optical fibers 136. The non-hardened fiber optic connectors 138 are inserted within the inner ports 130a of the fiber optic adapters 126a as shown at FIG. 15. As shown at FIG. 16, each of the hardened fiber optic adapters 126a includes a ferrule alignment sleeve 140a for receiving and aligning the ferrules of two fiber optic connectors desired to be coupled together. It will be appreciated that the ferrules support the ends of optical fibers that are coaxially aligned when the ferrules of the connectors are aligned within the ferrule alignment sleeve 140a. In other examples, the fiber optic cable 134 can include an optical fiber routed to the input of a passive optical power splitter within the housing 122. The passive optical power splitter is adapted to split an optical signal from the optical fiber into a plurality of splitter outputs. The outputs can be coupled to fiber optic pigtails having connectorized ends that are plugged into the inner ports 130a of the fiber optic adapters 126a. An example MST is described in U.S. Pat. No. 7,512,304, which is hereby incorporated by reference in its entirety.

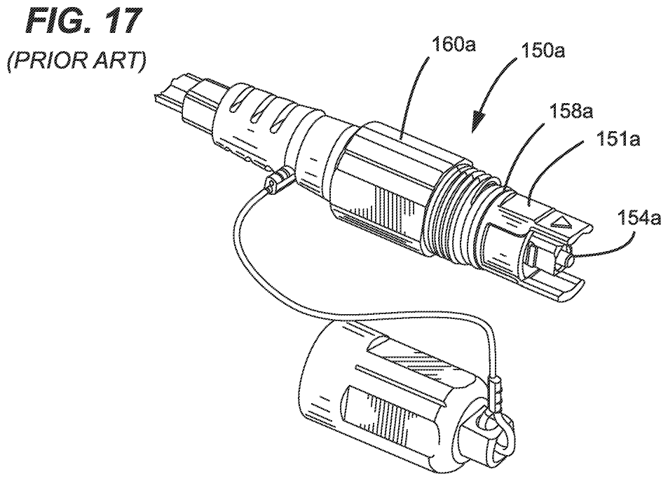

FIG. 17 depicts an example hardened fiber optic connector 150a adapted to mate with the hardened outer port 128a of the MST 120. The fiber optic connector 150a includes an outer shroud 151a that provides rotational keying with respect to the outer port 128a. A seal 158a on the shroud 151a is adapted to engage a sealing surface 172a within the outer port 128a to provide environmental sealing between the connector 150a and the adapter 126a. The connector 150a includes an inner plug supporting a ferrule 154a that is received within the ferrule alignment sleeve 140a when the connector 150a is inserted in the outer port 128a. The connector 150a includes a turn-to-secure fastener 160a having external threads that engage internal threads within the hardened port 128a to secure the connector 150a in the port 128a. Further details of the fiber optic connector 150a are provided in U.S. Pat. No. 7,113,679, which is hereby incorporated by reference in its entirety.

It will be appreciated that the MST 120 can be readily used to interconnect subscribers to a fiber optic network. Each of the hardened fiber optic adapters 126a represents a connection port for coupling a subscriber to the network. To connect a subscriber to the network, the plug 132a of one of the hardened fiber optic adapters 126a is removed to expose the hardened outer port 128a. A fiber optic drop cable connectorized by a hardened fiber optic connection is then coupled to the network by inserting the hardened fiber optic connector into the hardened outer port 128a. Upon installation of the hardened fiber optic connector in the hardened out port 128a, a fiber of the drop cable is optically connected to a corresponding optical fiber 136 of the fiber optic cable 134. For example, the hardened optical connector installed within the hardened outer port 128a connects with the corresponding non-hardened fiber optic connector 138 installed within the inner port 130a of the hardened fiber optic adapter to couple the drop line to the network.

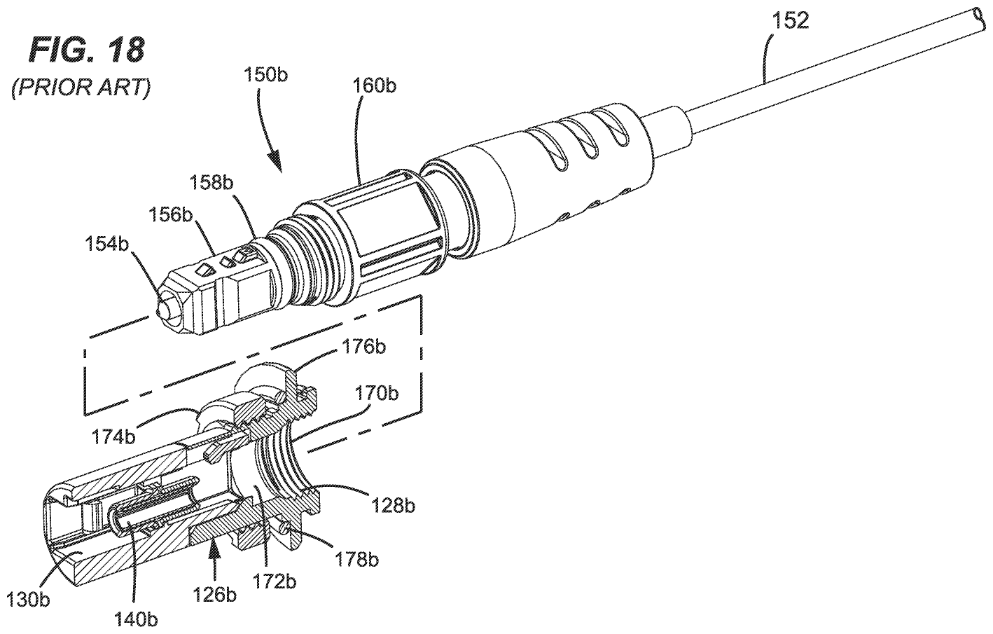

FIG. 18 shows another example of a hardened fiber optic connector 150b, depicted coupled to a drop cable 152. The hardened fiber optic connector 150b includes a ferrule 154b for supporting the end of an optical fiber of the drop cable 152. The ferrule 154b is mounted at the end of a connector body 156b adapted to be received within a hardened outer port 128b of a hardened fiber optic adapter 126b. In certain examples, the hardened fiber optic connector 150b includes an environmental seal 158b and a turn-to-secure fastener 160b. In the depicted example, the turn-to-secure fastener 160b includes threads. In the embodiment of FIG. 18, the fiber optic connector 150b is adapted to be inserted within the hardened port 128b of a fiber optic adapter 126b. The fiber optic adapter 126b also includes a non-hardened port 130b. A ferrule-alignment sleeve 140b is positioned within the interior of the fiber optic adapter 126b. In certain examples, the fiber optic adapter 126b can be mounted within an opening defined by an enclosure of a terminal such as the enclosure of an MST. The hardened port 128b includes internal threads 170b and a sealing surface 172b. Further details of the fiber optic connector 150b are provided in U.S. Pat. No. 7,744,288, which is hereby incorporated by reference in its entirety.

When the hardened fiber optic connector 150b is installed in the hardened port 128b of the fiber optic adapter 126b, the ferrule 154b is received within the ferrule alignment sleeve 140b, the environmental seal 158b seals against the sealing surface 172b, and external threads of the turn-to-secure fastener 160b engage with the internal threads 170b of the fiber optic adapter 126b to retain the hardened fiber optic connector 150b within the hardened port 128b. In certain examples, the fiber optic adapter 126b can be secured within an opening of an enclosure by an exterior nut 174b with a wall of the enclosure being captured between the nut 174b and a flange 176b. An environmental seal 178b can provide sealing between the flange 176b and the enclosure. It will be appreciated that the hardened fiber optic adapters 126a also include similar features for securing the fiber optic adapters 126a within openings of the MST housing 122, and for securing hardened fiber optic connectors within the hardened outer ports 128a.

It will be appreciated that the hardened fiber optic adapters 126a, 126b provide examples of fiber optic adapters having hardened fiber optic ports that can be incorporated within devices in accordance with the principles of the present disclosure. Similarly, the hardened fiber optic connectors 150a, 150b are examples of hardened fiber optic connectors that can be used in accordance with the principles of the present disclosure to make optical connections via insertion in hardened ports. In other examples, hardened fiber optic connectors each having more than one ferrule (e.g., duplex fiber optic connectors) or ferrules that support more than one optical fiber (e.g., multi-fiber ferrules) can be used in fiber optic connectors in accordance with the principles of the present disclosure. In certain examples, fiber optic connectors and fiber optic ports in accordance with the principles of the present disclosure can have different types of mechanical coupling interfaces such as threaded coupling interfaces, bayonet-style coupling interfaces, push-pull type connection interfaces or other connection interfaces. In certain examples, optical connection can be made directly between hardened connectors without intermediate adapters. It will be appreciated that other example hardened connector configurations and hardened port configurations are disclosed by U.S. Pat. Nos. 8,566,520; 9,304,262; 7,264,402; 7,758,389; and 7,744,288; which are hereby incorporated by reference in their entireties.

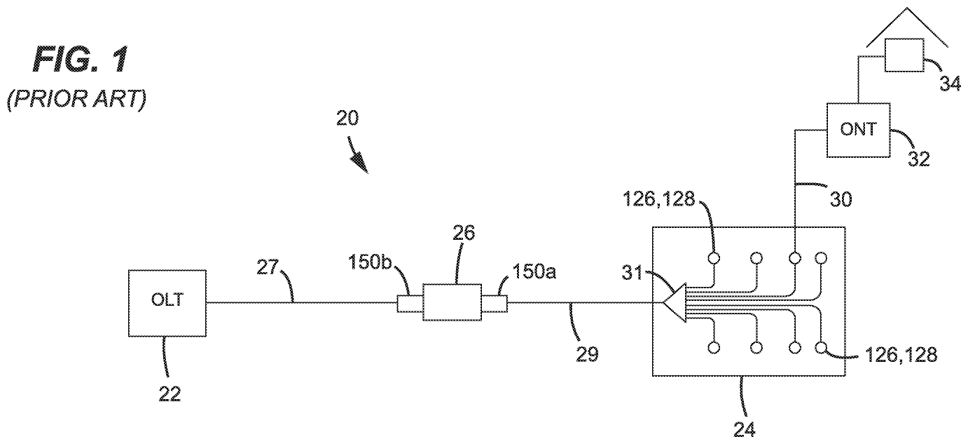

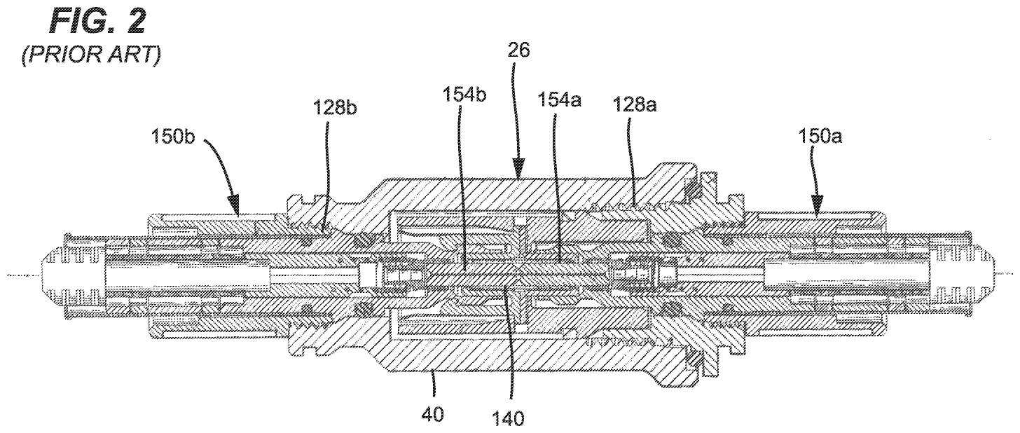

FIG. 1 schematically depicts a prior art fiber optic network architecture 20 that is representative of a GPON network. The architecture 20 includes an OLT 22 typically provided at a centralized location such as a service provider's central office. The architecture 20 also includes an MST 24 (e.g., a drop terminal) which is typically provided near the outer edge of the fiber optic network. The architecture 20 further includes a hardened in-line fiber optic adapter 26 for providing a hardened in-line connection location between fiber optic cables 27, 29 terminated by hardened fiber optic connectors 150b, 150a, respectively. The hardened fiber optic adapter 26 includes hardened ports 128a, 128b (shown in FIG. 2) for receiving the hardened fiber optic connectors 150a, 150b terminating the fiber optic cables 27, 29. The fiber optic cable 27 extends from the hardened fiber optic adapter 26 in an upstream direction toward the OLT 22. The fiber optic cable 29 extends from the hardened fiber optic adapter 26 in a downstream direction toward the MST 24. The MST 24 includes fiber optic adapters 126 having hardened outer ports 128 for receiving the connectorized ends of drop cables 30 routed to ONTs 32 positioned near subscriber locations 34.

In one example, the fiber optic network architecture 20 of FIG. 1 has a GPON architecture that supports 2.5 gigabits per second in the downstream direction and 1.25 gigabits per second in the upstream directions and that has a 1:32 split from the OLT 22 to the ONT 32. In certain examples, a 1×4 splitter is incorporated in the architecture at a location between the OLT 22 and the hardened fiber optic adapter 26. In certain examples, the MST 24 can include an internal passive optical power splitter 31 for splitting an input optical signal evenly between the plurality of hardened fiber outer ports 128 of the MST 24. For example, in the depicted MST 24 having eight hardened ports 128, the MST 24 can include an internal 1×8 passive optical power splitter. Of course, other split ratios can alternatively be used based in the network architecture and the port count being utilized.

It will be appreciated that the schematic architecture 20 of FIG. 1 is simplified, and that additional cables, enclosures or other components of the fiber optic network may be interposed between the hardened fiber optic adapter 26 and the OLT 22 and/or between the hardened fiber optic adapter 26 and the MST 24.

FIG. 2 depicts the hardened in-line fiber optic adapter 26 in more detail. The first and second hardened ports 128a, 128b of the in-line fiber optic adapter 26 are co-axially aligned with respect to one another. The ports 128a, 128b are positioned at opposite ends of an adapter housing 40 of the hardened fiber optic adapter 26. Within the housing 40 is a ferrule alignment structure such as a ferrule alignment sleeve 140 adapted to receive and coaxially align the ferrules 154a, 154b of the fiber optic connectors 150a, 150b inserted within the hardened ports 128a, 128b. The hardened fiber optic adapter 26 can be configured for coupling together two hardened fiber optic connectors 150a, 150b having different configurations, or the hardened fiber optic adapter ports can each have the same configuration so as to be configured for coupling together two identical hardened fiber optic connectors. Example hardened in-line adapters are disclosed by U.S. Pat. Nos. 8,827,571 and 8,882,364, which are hereby incorporated by reference in their entireties.

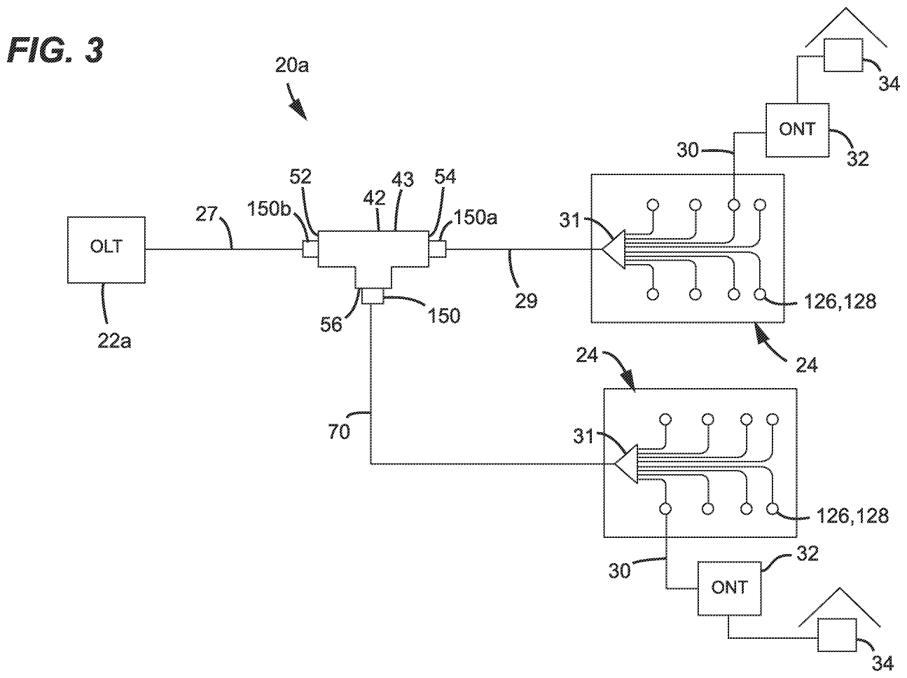

FIG. 3 schematically depicts an example architecture 20a which represents an example in accordance with the principles of the present disclosure for upgrading and increasing the capacity of the fiber optic architecture 20 of FIG. 1. In comparing the architecture 20a of FIG. 3 to the architecture 20 of FIG. 1, the hardened fiber optic adapter 26 has been replaced with a hardened passive optical splitter module 43 and the OLT 22 has been replaced with an upgraded OLT 22a. The upgraded OLT 22a preferably has a higher launch power and an enhanced sensitivity as compared to the OLT 22. Preferably, the upgraded OLT 22a is also adapted to support 10G-GPON or both GPON and 10G-GPON. In one example, the OLT 22 is a Class B device while the upgraded OLT 22a is a Class C device. The addition of the hardened passive optical splitter module 43 provides an additional network access port which allows an extra MST 24 to be added to the network architecture thereby increasing the capacity of the network architecture. The split ratio of the optical network is thereby increased from 1:32 to 1:64 so that the double number of ONTs for customers can be connected. All the ONTs are receiving both the GPON and the 10G-PON signals. Existing customers connected to the first MST terminal can continue to use a GPON ONT or they can choose to upgrade to a 10G-PON capable ONT so that they can enjoy higher downstream and upstream data speeds. Customers that are connected to the added MST can choose to connect a (less expensive) GPON ONT or a more capable 10G-PON ONT. So the new way of upgrading a PON network allows for the doubling of the number of customers and a 5-fold increase of total downstream data rate (from 2.5 gigabit per second to in total 12.5 gigabit per second with 10G-GPON customers sharing 10 gigabit per second downstream data rate and GPON customers sharing 2.5 gigabit per second data rate).

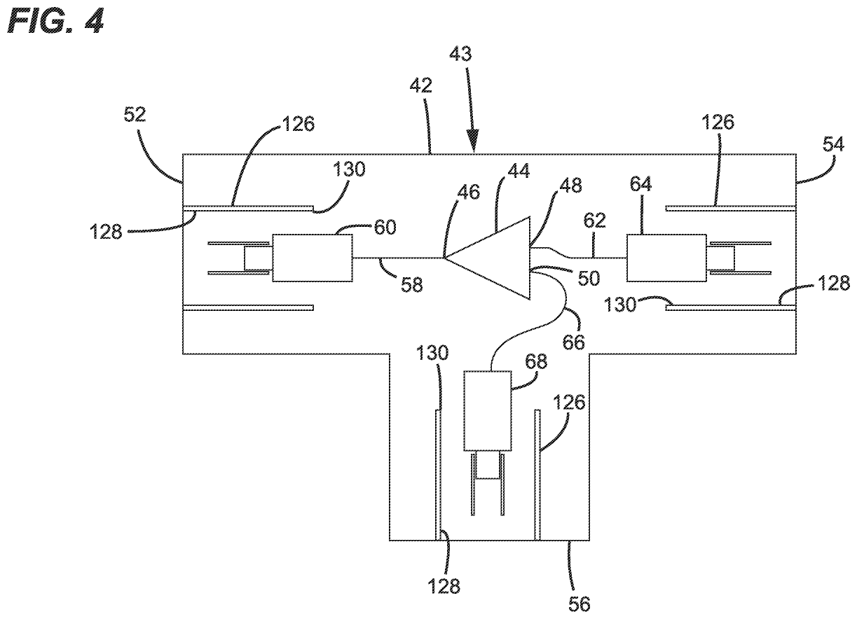

FIG. 4 is a more detailed schematic depiction of the hardened passive optical splitter module 43. The hardened passive optical splitter module 43 includes a housing 42 containing a passive optical power splitter 44. In the depicted example, the passive optical power splitter 44 is a 1×2 optical power splitter which includes a splitter input 46, a first splitter output 48 and a second splitter output 50. The hardened passive optical splitter module 43 includes an input location 52, a first output location 54 and a second output location 56 each having a hardened fiber optic adapter 126 including a hardened outer port 128 and an inner port 130. An input optical fiber 58 is coupled to the splitter input 46 and includes a connectorized end 60 installed at the inner port 130 of the fiber optic adapter 126 positioned at the input location 52. A first output fiber 62 is optically coupled to the first splitter output 48 and includes a connectorized end 64 installed within the inner port 130 of the fiber optic adapter 126 at the first output location 54. A second output fiber 66 is optically coupled to the second splitter output 50 and includes a connectorized end 68 installed within the inner port 130 of the fiber optic adapter 126 provided at the second output location 56. The hardened fiber optic connector 150b of the fiber optic cable 27 is coupled to the splitter module 43 at the input location 52 to optically connect the fiber optic cable 27 to the splitter input 46. The fiber optic connector 150a of the fiber optic cable 29 is installed within the hardened outer port 128 of the fiber optic adapter 126 at the first output location 54 to optically connect the fiber optic cable 29 to the first splitter output 48. A hardened fiber optic connector 150 terminating a cable 70 is installed in the hardened outer port 128 of the fiber optic adapter 126 at the second output location 56 to optically connect the added MST 24 to the second splitter output 50. In certain examples, a passive optical splitter such as a 1×8 splitter 31 can be provided in the added MST 24 for splitting the optical signal from the cable 70 to each of the output ports 128 of the MST 24.

It will be appreciated that the hardened outer ports 128 can be considered as female connectors. In the depicted hardened passive optical splitter module 43, the input location 52, the first output location 54 and the second output location 56 are all hardened female connectors. In other examples, the input location 52, the first output location 54 and the second output location 56 can all include male hardened fiber optic connectors. In still another example, the input location 52 can include a female hardened connector, and the first and second output locations 54, 56 can respectively include a male hardened fiber optic connector and a female hardened fiber optic connector. Still another example, the input location 52 can include a male hardened fiber optic connector, and the first and second output locations 54, 56 can respectively include a male hardened fiber optic connector and a female hardened fiber optic connector. In the depicted example, each of the connectors of the hardened passive optical splitter module 43 is a single-fiber connector. In other examples, the hardened fiber optic connectors of the hardened passive optical splitter module 43 can include hardened multi-fiber optical connectors.

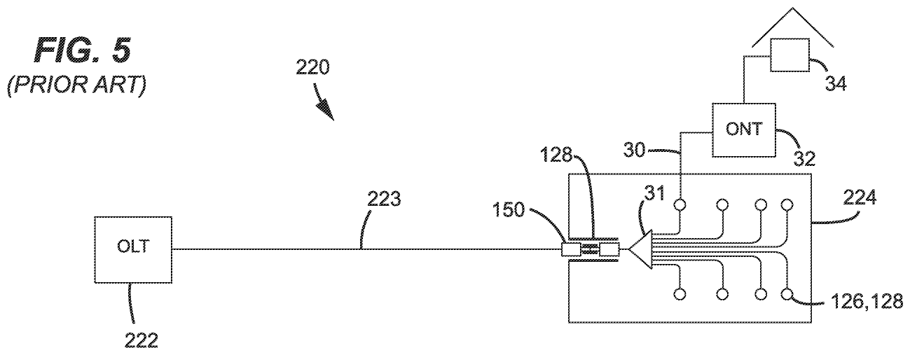

FIG. 5 schematically depicts another prior art fiber optic network architecture 220. The fiber optic network architecture 220 includes an OLT 222 typically provided at a centralized location. The architecture 220 also includes an MST 224 which is typically provided near the outer edge of the fiber optic network. An optical signal line 223 optically connects the OLT 222 to the MST 224 at a hardened port 128 at an input location of the MST 224. It will be appreciated that the schematic of FIG. 5 is highly simplified, and that in actual practice the signal line 223 include multiple optical cables coupled together and may also include multiple intermediate enclosures. In the depicted example, the signal line 223 is terminated by a hardened fiber optic connector 150 inserted within a hardened outer adapter port 128 at the input location of the MST 224. The hardened outer ports 128 of the MST 224 can receive the connectorized ends of drop cables 30 routed to ONTs 32 positioned near subscriber locations 34 to connect the subscriber locations to the network.

In one example, the fiber optic network architecture 220 of FIG. 5 has a GPON architecture that supports 2.5 gigabits per second in the downstream directions and 1.25 gigabit per second in the upstream direction and has a 1:32 split ratio from the OLT 222 to the ONT 32. In certain examples, the MST 224 can include an internal passive optical power splitter 31 for splitting an input optical signal from the signal line 223 evenly between a plurality of hardened outer output ports 128 of the MST 224. In the depicted example, MST 224 has eight hardened output ports 128 and one hardened input port 128, and the MST 224 can include an internal 1×8 passive optical power splitter for splitting the optical signal from the input port evenly to each of the output ports. Of course, other split ratios can be used as well depending upon the architecture of the network.

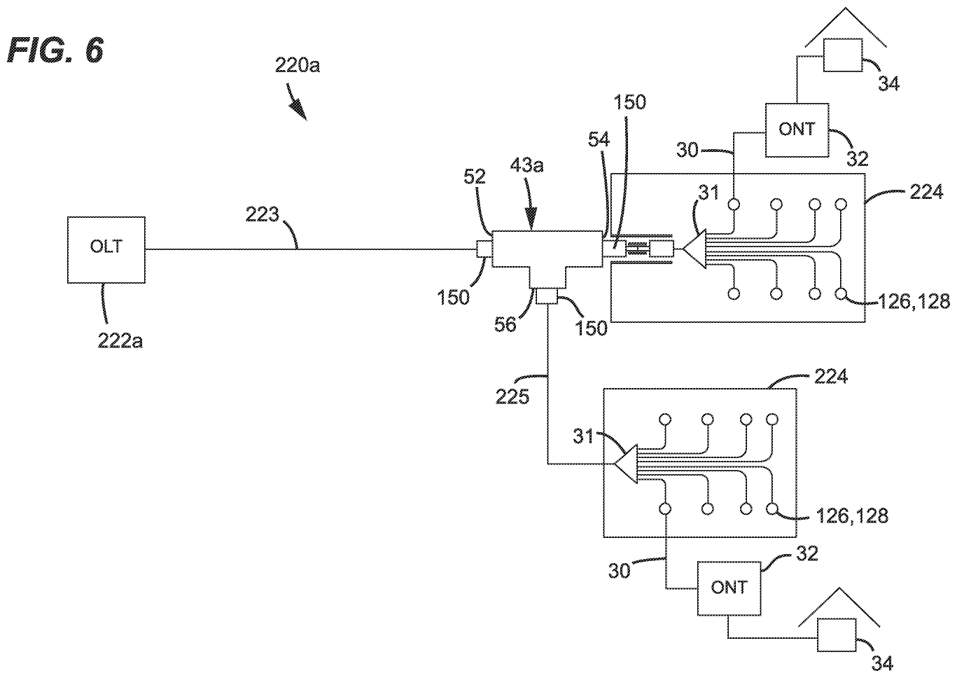

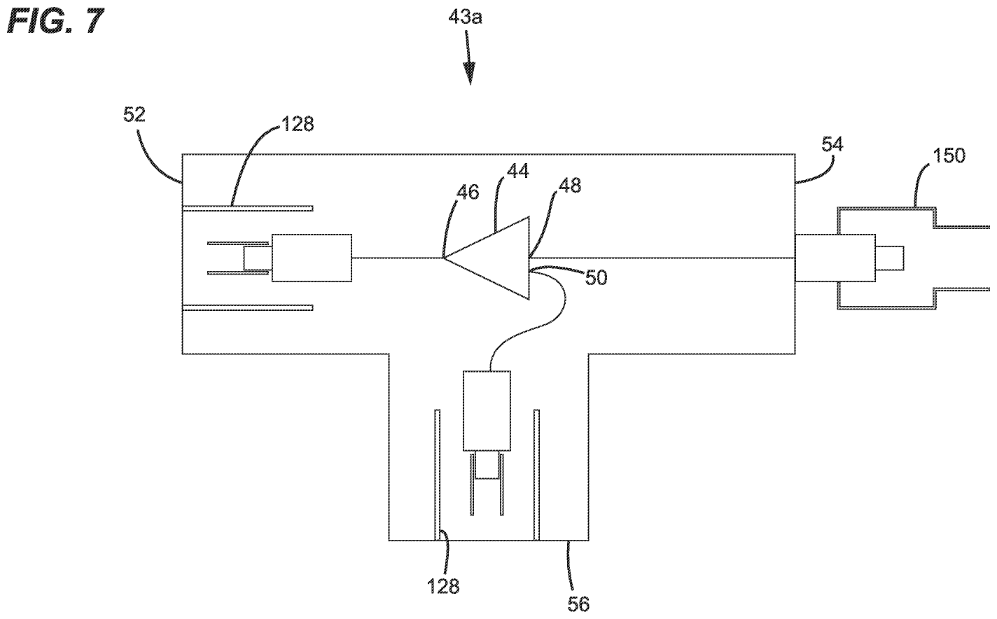

FIG. 6 schematically depicts a fiber optic architecture 220a which represents an example in accordance with the principle of the present disclosure for upgrading and increasing the capacity of the fiber optic network architecture 220 of FIG. 5. In the architecture 220a of FIG. 6, a passive optical splitter module 43a has been added to the architecture to provide an extra output port for connecting another MST 224 to the architecture. It will be appreciated that in certain examples, both of the MST's 224 can have the same configuration. The hardened passive optical splitter module 43a can have the same general configuration as the hardened passive optical splitter module 43 except the first output location 54 can include a male fiber optic connector 150 instead of a hardened fiber optic adapter port 128. The hardened fiber optic connector 150 at the first output location 54 allows the hardened passive optical splitter module 43a to be optically coupled to the MST 224 by mating the hardened fiber optic connector 150 at the first output location 54 with the hardened input port 128 of the MST 224. The input location 52 allows the optical signal line 223 to be coupled to the input 46 of the passive optical power splitter 44 by mating the hardened connector 150 at the end of the optical signal line 223 with the hardened fiber optic adapter port 128 of the input location 52 (see FIG. 7). The second output location 56 provides a connection location for connecting a cable 225 coupled to the newly added MST 224 to the second splitter output 50 of the passive optical power splitter 44. For example, the cable can be terminated by a hardened connector 156 that mates with a hardened adapter port 128 at the second output location 56. In certain examples, the cable 225 may include multiple cables coupled together by one or more hardened in-line adapters.

In addition to adding splitter 43a and the extra MST 224, the network can also be upgraded by replacing the OLT 222 with an OLT 222a that preferably can support 10G-GPON or both GPON and 10G-GPON, and also has an optical transmitter with increased launch power and an optical receiver with enhanced sensitivity as compared to the OLT 222. The ONT's can support GPON or be upgraded to support 10G-GPON, or can be configured to support both GPON and 10G-GPON.

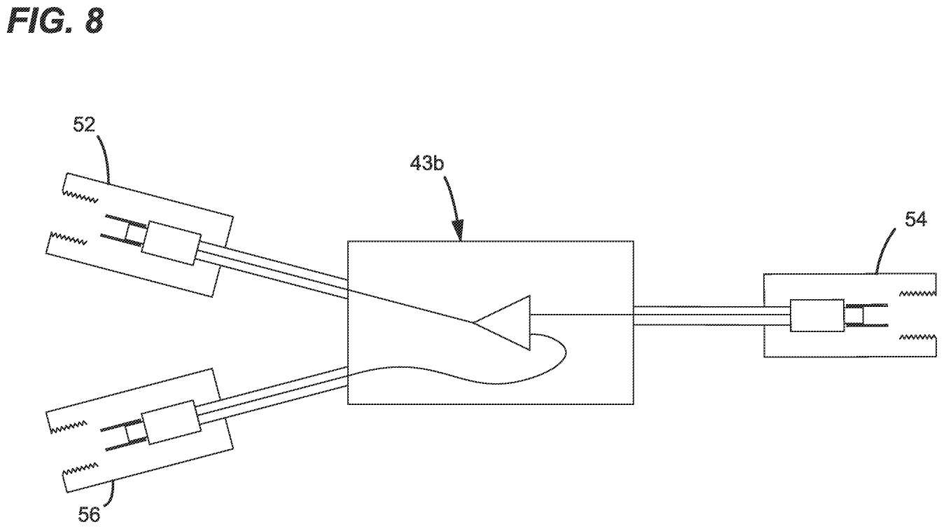

FIG. 7 is a more detailed schematic view of the hardened passive optical splitter module 43a. FIG. 8 depicts a further hardened passive optical splitter module 43b having the same general configuration as the passive optical splitter module 43a of FIG. 7, except the female connectors at the input location 52 and the second output location 56 are provided on tethers, and the male fiber optic connector provided at the first output location 54 is provided on a tether. It will be appreciated that the splitter module 43b can be used in place of the splitter module 43a to upgrade network architecture 223.

In the above examples, network expansion involves adding a splitting device at a de-mateable hardened connection location of the existing network. In other examples, splitting devices can be added via splicing or non-hardened de-mateable connections within existing or added network enclosures.

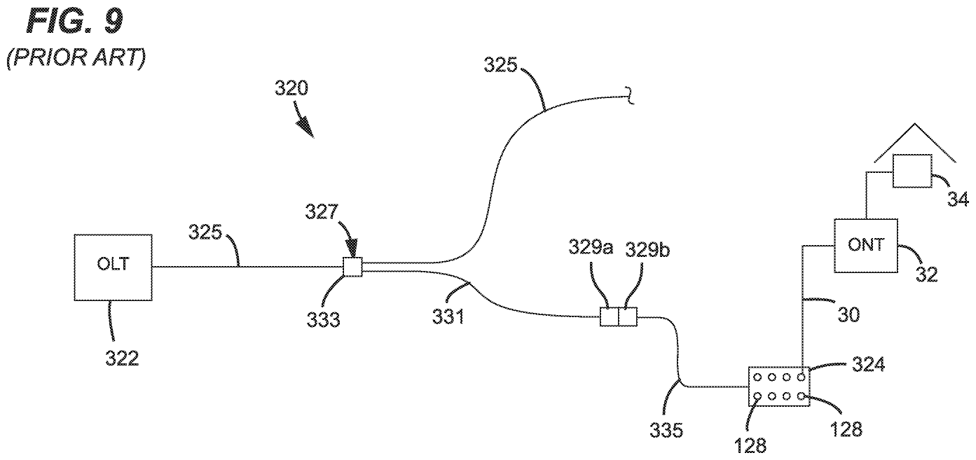

FIG. 9 schematically depicts another prior art fiber optic network architecture 320. The fiber optic network architecture 320 includes an OLT 322 typically provided at a centralized location. The fiber optic network architecture 320 also includes a multi-fiber optical distribution cable 325 for extending the network outwardly toward an outer edge of the network. The distribution cable 325 is optically connected to the OLT 322 and includes a mid-span breakout location 327 where at least one optical fiber is broken out from the distribution cable 325. In a preferred example, a plurality of optical fibers are broken out from the distribution cable 325 at the mid-span breakout location 327 and a remainder of the optical fibers of the distribution cable 325 are not broken out at the breakout location 327 and continue past the mid-span breakout location 327 in a downstream direction to extend the fiber optic network.

In the depicted example, the mid-span breakout location 327 includes a hardened, de-mateable multi-fiber optical connector 329a coupled to the optical fibers broken out from the distribution cable 325 at the mid-span breakout location 327. An example hardened, demateable multi-fiber fiber optical connector is disclosed by U.S. Pat. No. 7,264,402, which is hereby incorporated by reference in its entirety. The de-mateable hardened multi-fiber optical connector 329a is mounted at the end of a stub or tether 331 that projects from an enclosure 333 (e.g., an overmold) of the mid-span breakout location 327. The de-mateable hardened multi-fiber fiber optical connector 329a provides a connection location for connecting an MST 324 to the fiber optic network. In one example, the MST 324 does not include an internal passive optical splitter. Instead, an MST cable 335 routed from the breakout location 327 to an input of the MST 324 includes a plurality of optical fibers, which are broken out within the MST 324 and routed individually to outer adapter ports 128 of the MST 324. In certain examples, the MST cable 335 includes at least as many optical fibers as the MST 324 includes hardened outer adapter ports 128. In the depicted example, the MST cable 335 is terminated by a de-mateable multi-fiber hardened fiber optic connector 329b that mates and optically couples with respect to the de-mateable hardened multi-fiber optical connector 329a provided at the end of the tether 331. The hardened outer ports 128 of the MST 324 can receive the connectorized ends of drop cables 30 routed to an ONT 32 positioned near a subscriber location 34 to connect the subscriber location 34 to the network.

It will be appreciated that the schematic of FIG. 9 is highly simplified, and that in actual practice multiple cables and additional enclosures can be integrated throughout the network. In one example, the fiber optic network architecture 320 of FIG. 9 has a GPON architecture that supports 2.5 gigabits per second in the downstream directions and 1.25 gigabit per second in the upstream direction and has a 1:32 split ratio from the OLT 322 to the ONT 32. In the depicted example, the MST 324 has eight hardened output ports 128 and the MST cable includes eight fibers with each fiber corresponding to one of the hardened output ports 128 of the MST 324. Of course, MSTs having other numbers of ports can also be used.

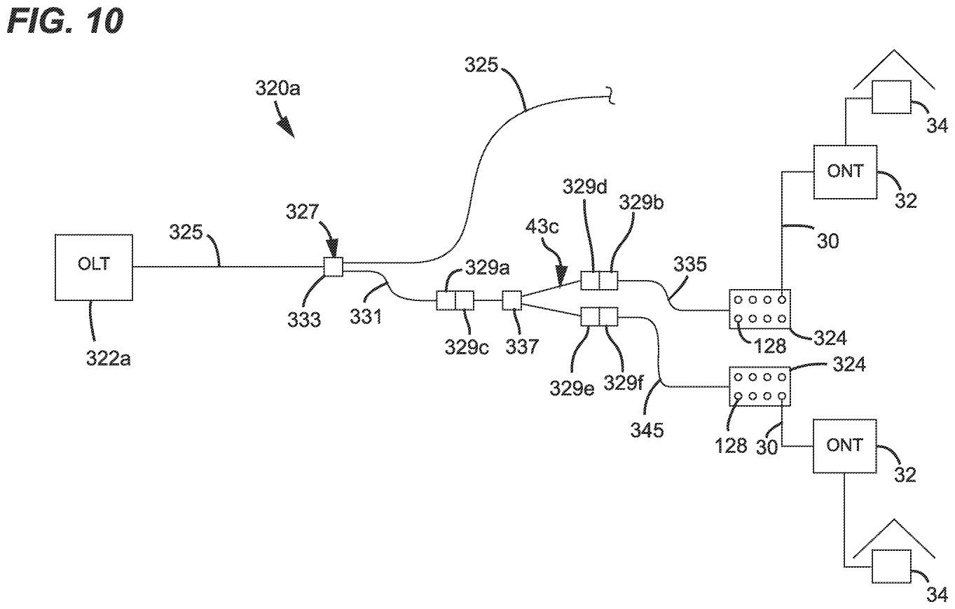

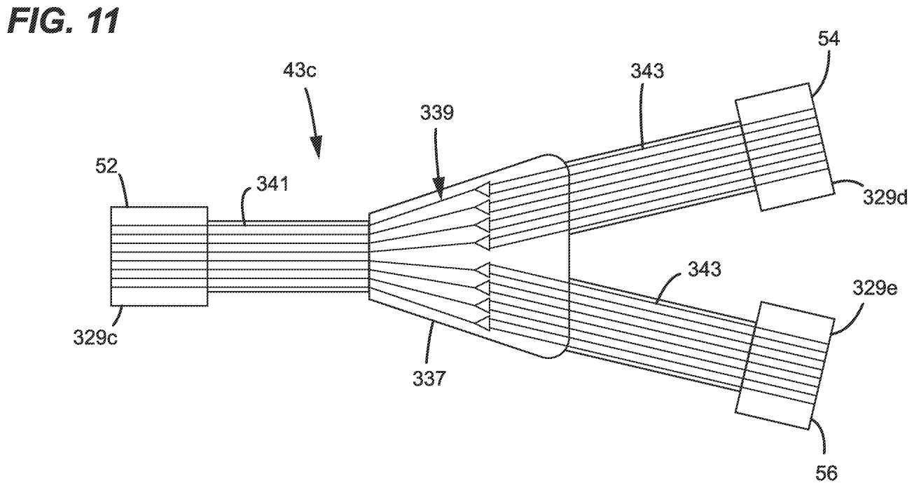

FIG. 10 schematically depicts a fiber optic architecture 320a which represents an example in accordance with the principles of the present disclosure for upgrading and increasing the capacity of the fiber optic network 320 of FIG. 9. In the fiber optic architecture 320a of FIG. 10, a hardened passive optical splitter module 43c has been added to the architecture to provide an extra output location for connecting another MST 324 to the architecture. It will be appreciated that in certain examples, both the original MST 324 and the added MST 324 can have the same configuration. The passive optical splitter module 43c includes a hardened de-mateable multi-fiber optical connector 329c at an input location 52 of the splitter module 43c, and hardened de-mateable multi-fiber optical connectors 329d, 329e located at output locations 54, 56, respectively, of the passive optical splitter module 43c. In the depicted example of FIG. 11, the connectors 329c-329d are mounted at the ends of stub cables (e.g., tethers) that project from a module housing 337. In the depicted example of FIG. 11, the connectors 329c-329e each support eight fibers. In the depicted example, a 1×2 passive optical power splitting arrangement 339 is provided within the module housing 337 of the optical splitter module 43c, although other split ratios can also be used. The splitting arrangement 339 is configured such that the splitter module 43c includes eight input fibers 341 and sixteen output fibers 343. The output fibers 343 are split evenly between the two output multi-fiber connectors 329d and 329e and the input fibers 341 terminate at the input multi-fiber connector 329c.

In other examples, alternative fiber counts may be used. For example, the splitter module may have two input fibers and four output fibers, or four input fibers and eight output fibers, or six input fibers and twelve output fibers, or twelve input fibers and twenty four output fibers, or other fiber counts. Other split ratios (e.g., 1×4, or 1×8 or other ratios) for the splitting arrangement 339 may also be used provided that the total loss budget for the network is respected. It will be appreciated that the MST cable 335 corresponding to the original, existing MST 324 is plugged into the output connectors 329d at the output location 54 of the splitter module 43c. An additional MST cable 345, connectorized with a multi-fiber de-mateable hardened connector 329f, is plugged into the output connector 329e at the output location 56 of the splitter module 43c. In this way, the new MST 324 is added to the network and provides additional hardened output ports 128 for connecting subscribers to the network.

Similar to the previous examples, in addition to adding the splitter module 43c and extra MST 324, the network can also be upgraded by replacing the OLT 322 with an OLT 322a that preferably can support 10G-GPON or both GPON and 10G-GPON, and also has an optical transmitter with increased launch power and an optical receiver with enhanced sensitivity as compared to the OLT 322. The ONT's 32 can support GPON or can be upgraded to support 10G-GPON or both GPON and 10G-GPON.

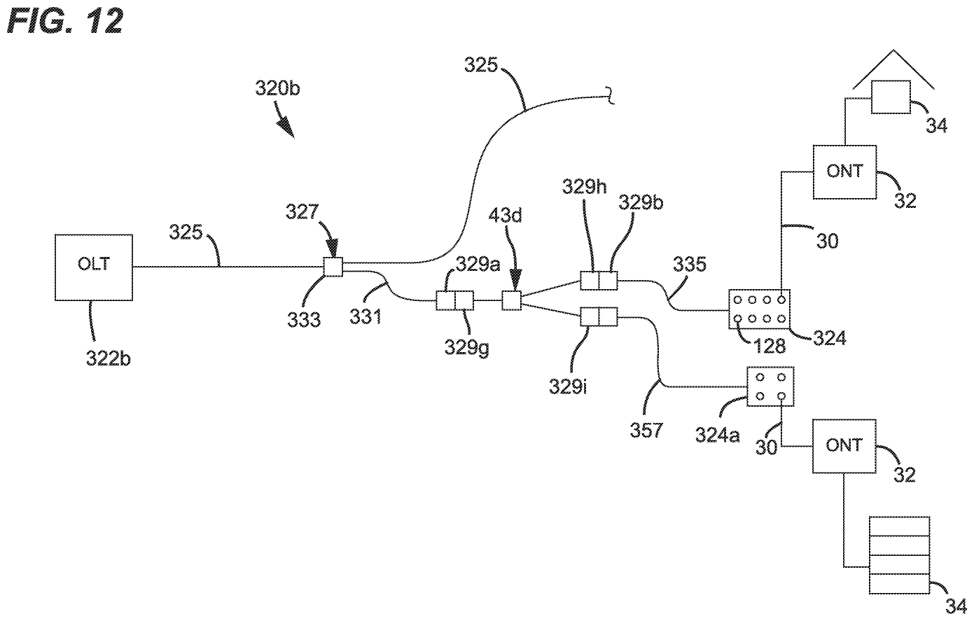

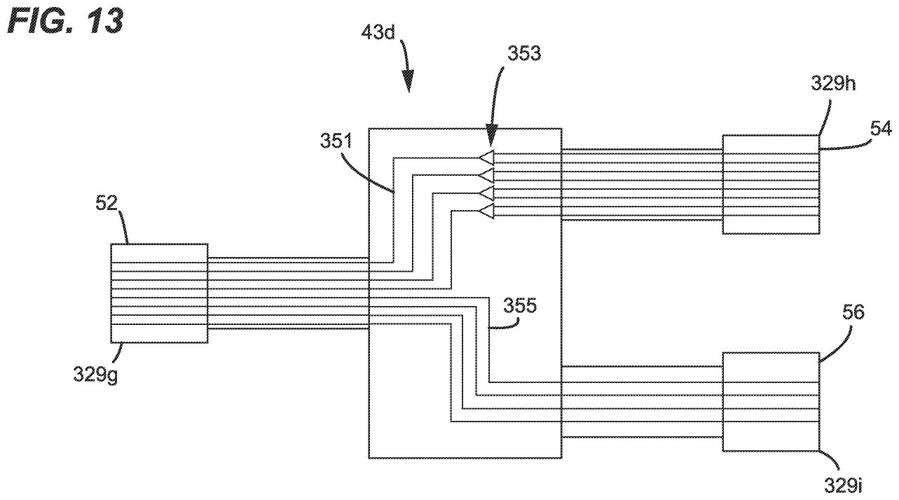

FIG. 12 schematically depicts another fiber optic architecture 320b which represents an example in accordance with the principles of the present disclosure for upgrading and increasing the capacity of the fiber optic network architecture 320 of FIG. 9. In the architecture 320b of FIG. 12, a hardened passive optical splitter module 43d has been added to the architecture to provide an extra output location for connecting another MST 324a to the architecture. In certain examples, the MST 324a has a lower port count as compared to the MST 324. As depicted at FIG. 13, the hardened passive optical splitter module 43d has de-mateable, hardened, multi-fiber optical connectors 329g-329i respectively at an input location 52 and two output locations 54, 56 of the splitter module 43d. The splitter module 43d provides both a splitting function and a pass-through function. For example, first optical fibers 351 terminating at the input connection location 52 are passively power split by a 1×2 splitting arrangement 353 (other split ratios can also be used) within the splitter module 43d. Outputs of the splitting arrangement 353 are routed to the output connector 329h which connects to the original MST 324 via drop cable 335 and connector 329b. Second optical fibers 355 terminating at the input connection location 52 are routed through the module without splitting (e.g., by-pass the splitter arrangement 353) and terminate at the multi-fiber output connector 329i. Thus, the output connection location 56 provides access to connection fiber optic service lines having a lower split ratio than the fiber optic service lines accessible at the output connection location 54. The lower split ratio service lines are capable of providing service to subscribers over a longer distance provided that the total loss budget is respected. An MST cable 357 is used to connect the MST 324a to the second output location 56 such that the fiber optic service lines are individually connected to separate ports of the MST 324a. Similar to the network architecture 320a, the network architecture 320b can include an OLT 322b that preferably can support 10G-GPON or both GPON and 10G-GPON, and also has an optical transmitter with increased launch power and an optical receiver with enhanced sensitivity as compared to the OLT 322 of the architecture of FIG. 9. The ONT's 32 can be adapted to support GPON, or upgraded to support 10G-GPON or both GPON and 10G-GPON.

What is claimed is:

1. A method for increasing the capacity of a passive optical network, the passive optical network including an existing multi-service terminal having a plurality of hardened fiber optic drop ports, the passive optical network also including an optical line terminal that provides service to the existing multi-service terminal, the method comprising:
upgrading the optical line terminal to support at least 10GPON and to have increased signal launch power and enhanced received signal sensitivity;
adding a passive optical splitter between the optical line terminal and the existing multi-service terminal;
connecting the existing multi-service terminal to a first output of the passive optical splitter; and
connecting an expansion multi-service terminal to a second output of the passive optical splitter.

2. The method of claim 1, wherein the passive optical splitter is added by replacing an existing hardened fiber optic adapter with the passive optical splitter, and wherein the passive optical splitter is enclosed in a splitter housing having hardened ports for receiving hardened fiber optic connectors.

3. The method of claim 1, wherein the passive optical splitter is added by connecting the passive optical splitter to a hardened input port of the existing multi-service terminal.

4. The method of claim 1, wherein the passive optical splitter is added at a de-mateable hardened connection location.

5. The method of claim 1, wherein the passive optical splitter is part of a splitting arrangement included as part of a module, wherein the module includes first input fibers routed to an input side of the splitting arrangement, wherein the splitting arrangement incudes output fibers that terminate at a first multi-fiber output connector, wherein the first input fibers terminate at an input multi-fiber connector, wherein second input fibers form pass-through fibers that terminate at the input multi-fiber connector, by-pass the splitting arrangement and terminate at a second multi-fiber output connector.

6. The method of claim 1, wherein the split ratio of the optical network is doubled from 1:32 to 1:64.

7. The method of claim 1, wherein a GPON ONT connected to the existing multi-service terminal is replaced with at 10G-PON ONT.

8. The method of claim 1, wherein a GPON ONT is connected to the expansion multi-service terminal.

9. The method of claim 1, wherein a 10G-PON ONT is connected to the expansion multi-service terminal.
